(19) United States
(12) Patent Application Publication
(10) Pub. No.: US 2003/0165147 A1
(43) Pub. Date: Sep. 4, 2003

(54) Memory-write decision circuit capable of simultaneously processing multiple items of data, and ATM switch having said circuit

(75) Inventor: Koushin Shimada, Fukuoka (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/953,405

(22) Filed: Sep. 17, 2001

(30) Foreign Application Priority Data
Sep. 18, 2000 (JP) 2000-282606

(51) Int. Cl. H04L 12/28; H04L 12/56

(52) U.S. Cl. 370/412; 370/428; 370/417

(57) ABSTRACT

Disclosed is device for suppressing a rise in the operating speed of the buffer controller in an ATM switch and reducing the operating speed in the write decision section of the switch. In a memory-write control circuit, data to be written to a memory having a predetermined memory capacity is provided with a priority. The circuit renders a write-enable/disable decision in such a manner that data of low priority will not be written to the memory in excess of a threshold value and data of high priority will not be written to the memory in excess of the memory capacity. A write decision circuit compares the threshold value and present queue length if the input data is valid data and, moreover, the data has a low priority, and compares the maximum capacity of the memory and the present queue length if the input data is valid data and, moreover, the data has a high priority, thereby to render an enable/disable decision with regard to writing of the input data to the memory. The write decision circuit converts multiple items of serially input control information to parallel data and renders the memory write-enable/disable decision with regard to multiple items of control information that have been rendered parallel.

### FIELD OF THE INVENTION

This invention relates to an ATM (Asynchronous Transfer Mode) switch and, more particularly, to a buffer control technique applied to an output-buffer-type switch.

### BACKGROUND OF THE INVENTION

An increase in network traffic due to the wide spread use of the Internet and an increase in the speed of ATM networks owing to the use of optical fiber or the like have been accompanied by efforts to raise the speed and enlarge the scale of a ATM switch.

Examples of architectures of ATM switches generally used heretofore are of the output-buffer type, shared-buffer type, input-buffer type and cross-point type, etc. The output-buffer-type switch, for example, has a high throughput and control is simple. However, in order to perform multiplexing and buffering of input ATM cells with a ATM switch of this type, processing speed is a bottleneck and it is difficult to obtain a high input/output link speed.

### SUMMARY OF THE DISCLOSURE

In ATM switches for which higher speed and larger scale are required, the output-buffer-type switch is such that the operating speed of a buffer controller rises in proportion to an increase in line speed or an increase in number of lines. As a consequence, it is difficult to raise switch speed and to enlarge the scale of the switch.

Accordingly, it is an object of the present invention to provide a device for suppressing a rise in the operating speed of a buffer controller of an ATM switch and reducing the operating speed in a write decision section of the switch.

In accordance with one aspect of the present invention, the foregoing object is accomplished by providing a memory-write control circuit wherein data to be written to a memory having a predetermined memory capacity is provided with a priority; and wherein said memory control circuit includes means that renders a write-enable/disable decision in such a manner that data of relatively low priority will not be written to the memory in excess of a preset threshold value, and data of relatively high priority will not be written to the memory in excess of the capacity of the memory, said control circuit comprising means for rendering the write-enable/disable decision simultaneously with respect to a plurality of items of data.

In accordance with another aspect of the present invention, is provided a memory control circuit having a memory management unit which receives, as control information, information that has been added onto input data for indicating validity or invalidity of the data, and priority information that has been added onto input data relating to discarding of this data, renders an enable/disable decision with regard to writing of the input data to a FIFO memory, which accumulates the data, based upon maximum memory capacity of the FIFO memory, predetermined threshold-value information for discarding data of relatively low priority and present queue length, which represents present amount of data accumulation in said memory, generates a write signal based upon result of the decision, and sends the write signal to said memory;

said memory receiving the write signal from said memory management unit, storing the input data in said memory in case of the write signal indicating write-enable, and reading out and outputting data, which has been stored in said memory, based upon a read signal output from said memory management unit;

wherein said memory management unit comprises:

conversion means which converts a plurality of items of the control information serially input thereto, to parallel control information; and

write decision means which compares the threshold value and the queue length if, based upon the control information, the input data is valid data and the data has a relatively low priority, and compares the maximum capacity of said memory and the queue length if, based upon the control information, the input data is valid data and the data has a relatively high priority, thereby to render the enable/disable decision regarding writing of the input data to said memory; said write-enable/disable decision being rendered in parallel with respect to a plurality of items of the control information that have been made parallel by said conversion means,

In accordance with another aspect of the present invention, is provided an ATM switch which comprises: a multiplexer which multiplexes cells supplied from a plurality of input lines;

a plurality of output buffers provided for corresponding ones of output lines;

a plurality of buffer management units, which are provided for corresponding ones of said plurality of output buffers, to which are input control information extracted by said multiplexer and including information indicating cell validity/invalidity and information indicating priority for cell discard, and to which are further input an externally entered output-buffer read-enable signal, for generating write and read-enable signals fed to said output buffers;

wherein each of said buffer management units includes:

a queue-length counter for managing output-buffer queue length by being counted up in accordance with number of items of cells to be written to said output buffer and counted down when one cell is read out of said output buffer;

a serial-to-parallel converter for converting a plurality of (N) items of the control information, which are input serially thereto, to N items of parallel control information;

a write decision unit, to which the N items of parallel control information are input, for comparing a threshold value and present queue length if, based upon the control information, the input data is valid data and the data has a relatively low priority, comparing the maximum capacity of said output buffer and the queue length if, based upon the control information, the input data is valid data and the data has a relatively high priority, thereby to render, in parallel, an enable/disable decision with regard to writing of N items of cell data to said output buffers, and generating N parallel write signals and outputting these signals in parallel, and having means for outputting a count-up signal to said queue-length counter so as to count up the queue length in conformity with number of cells for which writing is allowed among the N items of data; and

a first parallel-to-serial converter for converting N write signals, which are output from said write decision unit in parallel, to a serial signal.

In accordance with another aspect of the present invention, each of said buffer management units in the ATM switch further includes: a read decision unit that has means for generating an output-buffer read signal from a read-enable signal and the queue length recorded by said queue-length counter, and outputting a count-down signal to said queue-length counter so as to count down said counter by one when one cell is read out of said output buffer; and a second parallel-to-serial converter for outputting a signal, which is obtained by multiplexing a write signal output from said first parallel-to-serial converter and a read signal output from said read decision unit, to the corresponding output buffer as a serial read/write signal.

Still other objects and advantages of the present invention will become readily apparent to those skilled in this art from the following detailed descriptions wherein only the preferred embodiment of the invention is shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram useful in describing the structure of a memory control device according to the present invention;

FIG. 2 is a diagram useful in describing the structure of a memory management unit in the memory control device shown in FIG. 1;

FIG. 3 is a diagram illustrating the structure of a memory management unit according to an embodiment of the present invention;

FIG. 4 is a diagram useful in describing the timing operation of the memory management unit according to this embodiment;

FIG. 5 is a diagram illustrating the structure of a write decision unit according to an embodiment of the present invention;

FIG. 6 is a diagram illustrating the structure of an output-buffer-type ATM switch to which the present invention is applied;

FIG. 7 is a diagram illustrating the structure of a buffer management unit constituting an embodiment of an output-buffer-type ATM switch according to the present invention; and

FIG. 8 is a timing circuit useful in describing the operation of the buffer management unit constituting the embodiment of the output-buffer-type ATM switch according to the present invention.

### PREFERRED EMBODIMENTS OF THE INVENTION

A preferred embodiment of the present invention will be described in the below. For practicing the present invention, in a memory control circuit for controlling the writing of data to a memory, a circuit which simultaneously processes, for multiple items of data, the adoption and rejection of data is accommodated in a section for controlling the writing of data.

More specifically, in a preferred embodiment of the present invention, there is provided a memory control device having a memory management unit which receives as control information, information that has been added onto the input data for indicating the validity or invalidity of the data, and priority information that has been added onto the input data relating to discarding of this data, renders an enable/disable decision with regard writing of the input data to a FIFO memory based upon maximum memory capacity of the FIFO memory, threshold-value information for discarding data of low priority and present queue length, creates a write signal based upon result of the decision and sends the write signal to the memory.

The memory management unit creates a read signal for instructing reading data from the memory, based upon a signal that enables reception of data which has been entered externally, and the queue length, and sends the read signal to the memory.

The memory stores the input data in accordance with the input data and the write signal supplied from the memory management unit, and reads out and outputs data that has been stored therein in accordance with the read signal supplied from the memory management unit.

If input data is valid data and, moreover, has a low priority, the memory management unit compares the threshold value and the queue length.

If the input data is valid data and, moreover, has a high priority, the memory management unit compares the maximum capacity of the memory and the queue length.

Enabling or disabling the writing of the data to the memory is decided by a write decision unit.

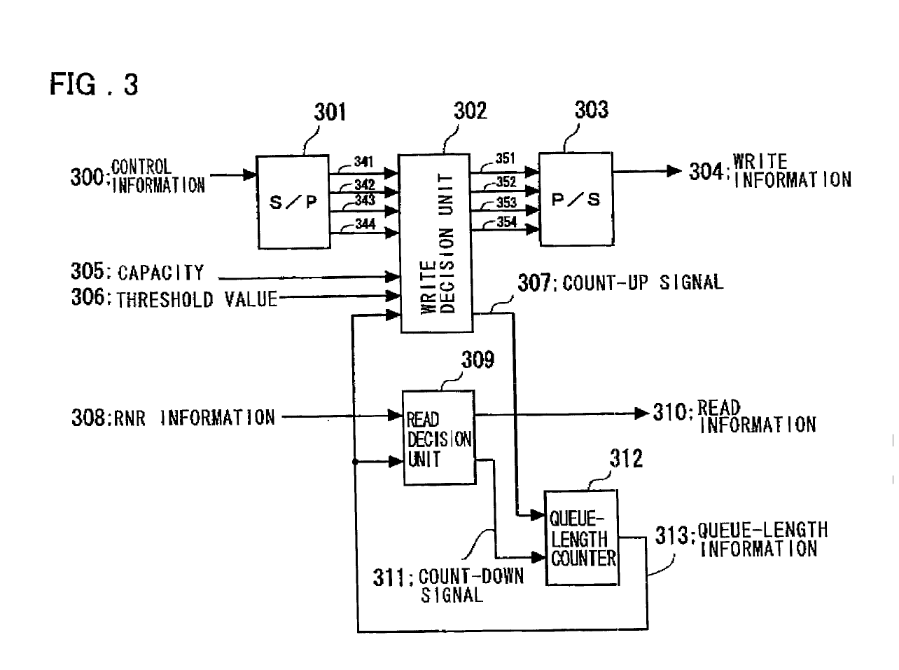

Specifically, multiple (N) items of control information input serially are converted to multiple (N) items of parallel control information by a serial-to-parallel conversion circuit (301 in FIG. 3), and the write decision unit (302 in FIG. 3) renders, in parallel (and therefore simultaneously), multiple enable/disable decisions with regard to writing of data to the memory with respect to multiple items of control information (341 to 344 in FIG. 3) that have been rendered parallel.

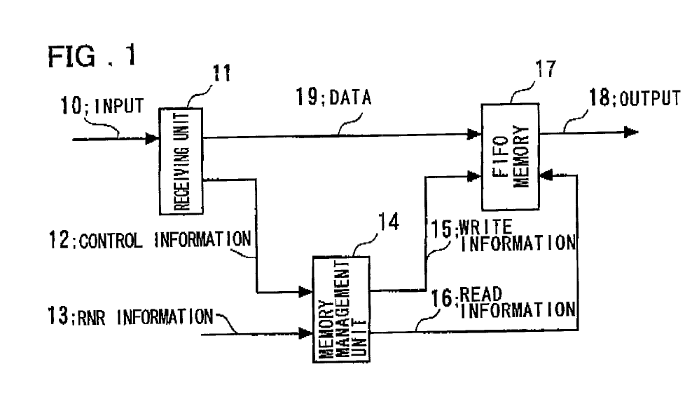

The write-enable/disable decision output in parallel by the write decision circuit (302 in FIG. 3) is converted to a serial signals by a parallel-to-serial conversion circuit (303 in FIG. 3) and the serial signal is fed to a FIFO memory (17 in FIG. 1) as write information (15 in FIG. 1).

A preferred embodiment of the present invention will now be described in detail with reference to the drawings.

FIG. 1 illustrates the structure of a memory control circuit constituting an embodiment of the present invention. The memory control circuit performs a FIFO (First In, First Out) operation.

Data (receive data) that enters from an input 10 is sent to a FIFO memory 17 after a receiving unit 11 makes the data conform to the processing timing within the memory control circuit.

The receiving unit 11 simultaneously extracts information attached to each item of data to indicate whether the data is valid or invalid, and information attached to each item of data to indicate the priority thereof for discard purposes, and sends the extracted information to a memory management unit 14 as control information 12.

The memory management unit 14 creates a signal, which directs writing of input data to the memory, based on a maximum capacity that is stored in the memory management unit 14, threshold-value information for discarding data of low priority, and current amount of data accumulation (referred to as “queue length” below) in the FIFO memory 17, and sends the signal to the FIFO memory 17 as write information 15.

Further, the memory management unit 14 creates read information 16, which is a signal that enables read-out of stored data from the memory, based on RNR (Receive Not Ready) information 13, which is a signal that is entered from a downstream device (not shown) for indicating the allowance of reception of data, and queue length (the current amount of accumulated data), and sender the read information 16 to the FIFO memory 17, The RNR information 13 is a signal that notifies of fact that reception of data is not allowed. The RNR information 13 usually is active at logic value “0”. Read-out is disabled by logic value “0” (refusal of reception from the downstream device) and enabled by logic value “1”. In this specification is employed such a logic that it is when the RNR information 13 is at logic value “1” that data read is allowed.

The FIFO memory 17, after aligning phases of data 19 received by the receiving unit 11 and the write information 15 received from the memory management unit 14, stores the data 19 in the internal memory in first-in, and first-out way in accordance with the write information 15.

Further, the FIFO memory 17, based on the read information 16, reads out the data that has been stored in the internal memory and provides the data to an output 18.

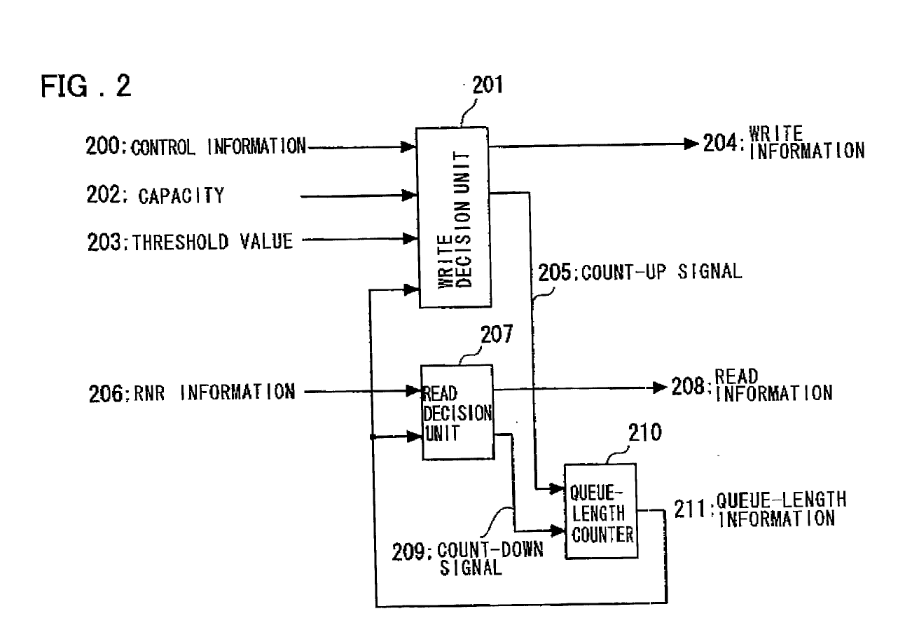

FIG. 2 is a diagram showing an example of the structure of the memory management unit 14 depicted in FIG. 1.

As shown in FIG. 2, the memory management unit 14 includes a write decision unit 201, a read decision unit 207 and a queue-length counter 210.

The write decision unit 201 receives control information 200 (which corresponds to control information 12 in FIG. 1) from the receiving unit 11, memory maximum-capacity information 202, threshold-value information 203 and queue-length information 211. On the basis of the control information 200, the write decision unit 201 decides whether the data received in the receiving unit 11 is valid or invalid.

If the data is valid data and, moreover, the data has a low priority, then the write decision unit 201 compares the threshold-value information 203 and the current queue-length information 211.

If the data is valid data and, moreover, the data has a high priority, then the write decision unit 201 compares the memory maximum-capacity information 202 and the queue-length information 211.

If the data is invalid, then the data is discarded.

The conditions under which the write decision unit 201 enables writing of data to the memory are as follows:

(1) threshold value>=queue length+1 in case of low-priority data; and

(2) maximum capacity>=queue length+1 in case of high-priority data.

If either of these conditions is met, the write decision unit 201 makes write information 204 (which corresponds to the write information 15 in FIG. 1) active (logic value “1”) and send this information to the FIFO memory 17. In this case, the write decision unit 201 sends a counter count-up signal 205 to the queue-length counter 210 so as to increment the queue length by +1.

The read decision unit 207 receives RNR information 206 (which corresponds to the RNR information 13 in FIG. 1), and the queue-length information 211. If the RNR information 206 is not active and therefore indicates that read-out is allowed (logic value “1”) and, moreover, the queue length is equal to or greater than 1, then, in order to read out the stored data from memory, the read decision unit 207 makes read information 208 active (logic value “1”) and sends this information to the FIFO memory 17. Further, in this case, the read decision unit 207 sends a counter count-down signal 209 to the queue-length counter 210 to decrement the counter by −1.

The, queue-length counter 210 is incremented by +1 and decrement by −1 by the count-up signal 205 and count-down signal 209, respectively, thereby generating the queue-length information 211 that indicates the number of items of data that have been stored in the FIFO memory 17.

FIG. 3 is a diagram illustrating an arrangement in which four items of data can be processed simultaneously in the write decision unit of the memory management unit 14 according to an embodiment of the present invention.

As shown in FIG. 3, a write decision unit 302 in this embodiment has a control-information input section provided with a serial-to-parallel (S/P) conversion circuit 301 for converting serially input control information to parallel information, and a write-information output section provided with a parallel-to-serial (P/S) conversion circuit 303 for converting parallel write information to serial information.

In order to reduce the operating speed of the write decision unit 302, the serial-to-parallel conversion circuit 301 converts serially input control information 300 (which corresponds to control information 12 in FIG. 1) to four items of parallel data. The serial-to-parallel conversion circuit 301 has a timing adjustment function for reducing data speed to one-fourth and four outputting control information 341 to 344 of four items of data upon aligning the phases thereof.

The parallel-to-serial conversion circuit 303 multiplexes parallel signals 351 to 354 of four items of data output from the write decision unit 302 and outputs serial-data write information 304.

In order that the write decision unit 302 may process four items of control information simultaneously, a count-up signal 307 that is output from the write decision unit 302 to a queue length counter 312 is set to each of the following values:

(1) “+0” (do not increment), which indicates no writing of data to memory;

(2) “+1” (count up by one), which indicates writing of one item of data;

(3) “+2” (count up by two), which indicates writing of two items of data;

(4) “+3” (count up by three), which indicates writing of three items of data; and

(5) “+4” (count up by four), which indicates writing of four items of data.

The queue length counter 312 comprises an up/down counter that performs “+1”, “+2”, “+3”, “+4” count-up operations in response to the count-up signal 307 that is supplied from the write decision unit 302 and a “−1” count-down operation in response to a count-down signal 311 that is supplied from a read decision unit 309.

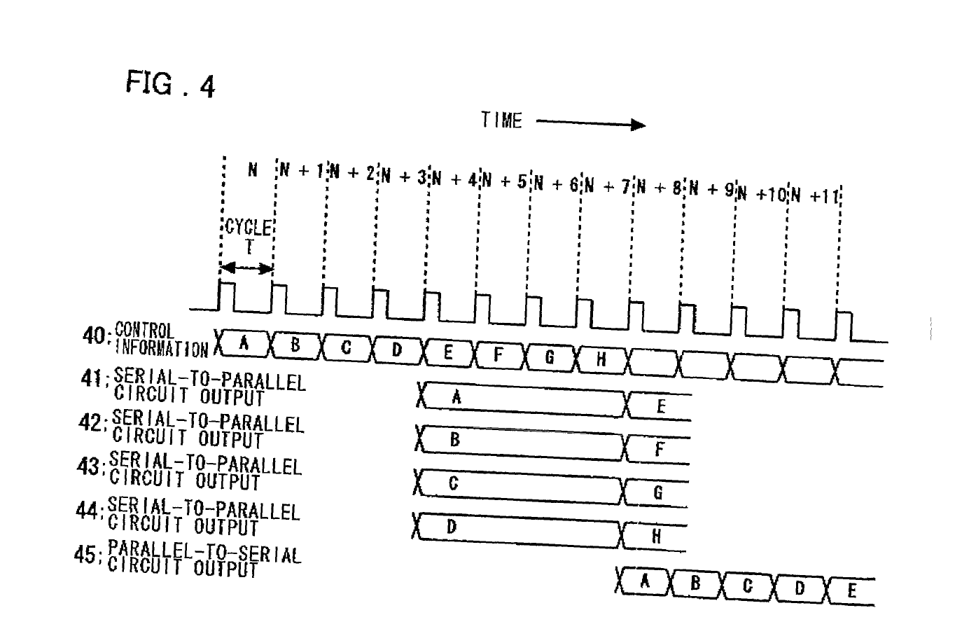

FIG. 4 is a diagram illustrating operation timing from receipt of the control information 300 to output of the write information 304 in the circuit arrangement of the embodiment illustrated in FIG. 3. The operation of this embodiment of the invention will be described with reference to FIGS. 3 and 4.

In FIG. 4, let T represent a time interval of one cycle at which the control information 40 (which corresponds to control information 300 in FIG. 3) is received. If A control information is received in an Nth cycle, B control information in an (N+1)th cycle, C control information in an (N+2)th cycle and D control information in an (N+3)th cycle, then, four cycles (N+4 cycles) after the reception of the A control information, the serial-to-parallel conversion circuit 301 converts the speed of the A, B, C and D control information to one-fourth, aligns the phases thereof and outputs the information to the write decision unit 302 in parallel (41 to 44 in FIG. 4, 341 to 344 in FIG. 3).

On the basis of the A, B, C and D control information 341 to 344 output in parallel from the serial-to-parallel conversion circuit 301 at the timing of the (N+4)th cycle, the write decision unit 302 renders a write-enable/disable decision with regard to A, B, C and D simultaneously over four cycles (cycles N+4 to N+7) and outputs A, B, C and D write information 351 to 354 (see FIG. 3), which is the result of the decision operation, to the parallel-to-serial conversion circuit 303.

The parallel-to-serial conversion circuit 303 multiplexes the A, B, C and D write information 351 to 354 after the write-enable/disable decision performed by the write decision unit 302 is completed (i.e., from cycle N+8 in FIG. 4) and outputs the multiplexed signal as the serial-data write information 304 (45 in FIG. 4).

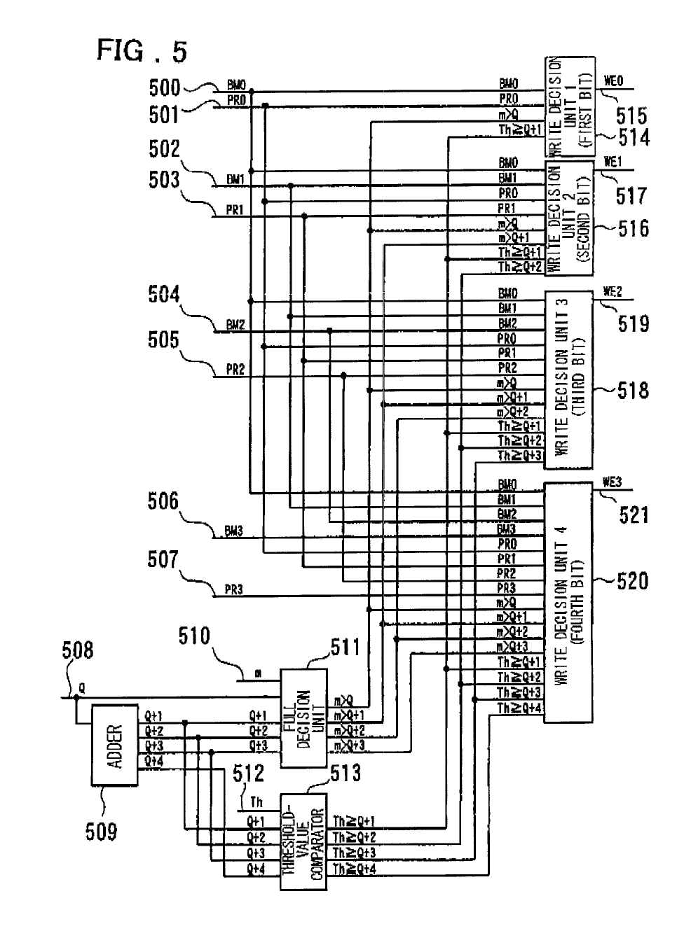

FIG. 5 illustrates a structure of a write decision circuit based upon 4-input simultaneous processing in an embodiment of the present invention.

Reference numbers 500 to 507 in FIG. 5 are signals that constitute the control information received by the write decision unit 302 of FIG. 3.

Signal 500, which is information (signal BM0) indicating the validity/invalidity of a first item of data among four items of data, becomes logic value “1” if the data is valid data.

Signal 501, which is information (signal PR0) indicating priority for discarding the first item of data among four items of data, becomes logic value “1” if the data is difficult to discard.

Signal 502, which is information (signal BM1) indicating the validity/invalidity of a second item of data among four items of data, becomes logic value “1” if the data is valid.

Signal 503, which is information (signal PR1) indicating priority for discarding the second item of data among four items of data, becomes logic value “1” if the data is difficult to discard.

Signal 504, which is information (signal BM2) indicating the validity/invalidity of a third item of data among four items of data, becomes logic value “1” if the data is valid.

Signal 505, which is information (signal PR2) indicating priority for discarding the third item of data among four items of data, becomes logic value “1” if the data is difficult to discard.

Signal 506, which is information (signal BM3) indicating the validity/invalidity of a fourth item of data among four items of data, becomes logic value “1” if the data is valid.

Signal 507, which is information (signal PR3) indicating priority for discarding the fourth item of data among four items of data, becomes logic value “1” if the data is difficult to discard.

Signal 508 indicates a queue length (signal Q) (queue-length information 313 in FIG. 3). An adder 509 creates a value (signal Q+1) obtained by adding I to the queue length, a value (signal Q+2) obtained by adding 2 to the queue length, a value (signal Q+3) obtained by adding 3 to the queue length, and a value (signal Q+4) obtained by adding 4 to the queue length.

Signal 510 indicates the maximum capacity (signal m) (305 in FIG. 3) of the memory.

The maximum capacity m (510), the queue length Q (508) and the values (Q+1), (Q+2), (Q+3) obtained by adding 1, 2 and 3, respectively, to the queue length Q are fed to a full decision unit 511.

The full decision unit 511 compares the maximum capacity m and Q, m and Q+1, m and Q+2, and m and Q+3, and creates a signal that becomes logic value “1” when each of the following hold:

m>Q

m>Q+1

m>Q+2

m>Q+3

(signals m>Q, m>Q+1, m>Q+2, m>Q+3 are output from the full decision unit 511 in FIG. 5).

Reference number 512 denotes a threshold value (signal Th) (306 in FIG. 3) for discarding low-priority data. The threshold value (Th) and the values (Q+1), (Q+2), (Q+3), (Q+4) obtained by adding 1, 2, 3 and 4, respectively, to the queue length Q are input to a threshold-value comparator 513.

The threshold-value comparator 513 compares the threshold value Th with these values and creates a signal that becomes logic value “1” when each of the following hold:

Th>=Q+1

Th>=Q+2

Th>=Q+3

Th>=Q+4

(signals Th>=Q+1, Th>=Q+2, Th>=Q+3, Th>=Q+4 are output from the threshold-value comparator 513 in FIG. 5).

Reference number 514 denotes a write decision unit for a first item of data among four items of data. The inputs to the write decision unit 514 are BM0, PR0, m>Q and Th>Q+1, on the basis of which the unit creates write information (a signal WE0) 515 concerning the first item of data among the four items of data.

Reference number 516 denotes a write decision unit for a second item of data among four items of data. The inputs to the write decision unit 516 are BM0, BM1, PR0, PR1, m>Q, m>Q+1, Th>=Q+1 and Th>Q+2, on the basis of which the unit creates write information (a signal WE1) 517 concerning the second item of data among the four items of data.

Reference number 518 denotes a write decision unit for a third item of data among four items of data. The inputs to the write decision unit 518 are BM0, BM1, BM2, PR0, PR1, PR2, m>Q, m>Q+1, m>Q+2, Th>=Q+1, Th>=Q+2 and Th>=Q+3, on the basis of which the unit creates write information (a signal WE2) 519 concerning the third item of data among the four items of data.

Reference number 520 denotes a write decision unit for a fourth item of data among four items of data. The inputs to the write decision unit 520 are BM0, BM1, BM2, BM3, PR0, PR1, PR2, PR3, m>Q, m>Q+1, m>Q+2, m>Q+3, Th>m Q+1, Th>=Q+2, Th>=Q+3 and Th>=Q+4, on the basis of which the unit creates write information (a signal WE3) 521 concerning the fourth item of data among the four items of data

The items of write information 515, 517, 519, 521 (WE0 to WE3) (which corresponds to 351 to 354 in FIG. 3) are signals that become logic value “1” if data is to be written to the memory 17.

The count-up signal to the queue-length counter makes combined use of the write information 515, 517, 519, 521 (WE0 to WE3). That is, if only one bit of any of the items of write information WE0 to WE3 becomes logic value “1”, then the queue length counter 312 (see FIG. 3) is instructed to increments its count by “+1”.

If any two bits among the items of write information WE0 to WE3 become logic value “1”, then the queue length counter 312 is instructed to increment its count by “+2”.

If any three bits among the items of write information WE0 to WE3 become logic value “1” then the queue length counter 312 is instructed to increment its count by “+3”.

If all four bits among the items of write information WE0 to WE3 become logic value, “1”, then the queue length counter 312 is instructed to increment its count by “+4”.

Equations (1) below illustrate one example of logic equations for implementing the circuit structures of the write decision units 514, 516, 518 and 520 shown in FIG. 5. In equation 1, enable signals EN0 to EN3 correspond to the write information WF0 to WE3 in FIG. 5, and BM0 to BM3, PR0 to PR3, in, Th, Q, Q+1, Q+2, Q+3 correspond to the signals shown in FIG. 5.

In Equations (1), “.” represents an AND operation, “+” represents an OR operation, and the bar over a character string indicates a NOT (inversion) operation.

| | | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|---|
| [symbol] | = | | | | | | | BM0 | | | | | | | [symbol] | PR0 | | | | | | | | | [symbol] | m > Q | | | | | | |
| | + | | | | | | | BM0 | | | | | | | | | [symbol] | (Th ≧ Q + 1) | | | | | | | [symbol] | m > Q | | | | | | |
| [symbol] | [symbol] | | | | | BM1 | [symbol] | \overline{BM0} | | | | | [symbol] | PR1 | | | | | | | | | | | [symbol] | m > Q | | | | | | |
| | + | | | | | BM1 | [symbol] | \overline{BM0} | | | | | | | | | [symbol] | (Th ≧ Q + 1) | | | | | | | [symbol] | m > Q | | | | | | |
| | + | | | | | BM1 | [symbol] | BM0 | | | | | [symbol] | \overline{PR1>} | | | | | [symbol] | (Th ≧ Q + 2) | | | | | | | [symbol] | m ≧ Q + 1 | | | | |
| | + | | | | | BM1 | [symbol] | BM0 | | | | | [symbol] | PR1 | [symbol] | \overline{PR0} | [symbol] | \overline{(Th ≧ Q + 1)} | | | | | | | [symbol] | m > Q | | | | | | |
| | + | | | | | BM1 | [symbol] | BM0 | | | | | [symbol] | PR1 | [symbol] | PR0 | | | | | | | | | | | [symbol] | m ≧ Q + 1 | | | | |
| | + | | | | | BM1 | [symbol] | BM0 | | | | | [symbol] | PR1 | | | [symbol] | (Th ≧ Q + 1) | | | | | | | | | [symbol] | m ≧ Q + 1 | | | | |
| [symbol] | [symbol] | | | BM2 | [symbol] | \overline{BM1} | [symbol] | \overline{BM0} | | | [symbol] | PR2 | | | | | | | | | | | | | [symbol] | m > Q | | | | | | |
| | + | | | BM2 | [symbol] | \overline{BM1} | [symbol] | \overline{BM0} | | | | | | | | | [symbol] | (Th ≧ Q + 1) | | | | | | | [symbol] | m > Q | | | | | | |
| | + | | | BM2 | [symbol] | \overline{BM1} | [symbol] | BM0 | | | [symbol] | \overline{PR2} | | | | | | | [symbol] | (Th ≧ Q + 2) | | | | | | | [symbol] | m ≧ Q + 1 | | | | |
| | + | | | BM2 | [symbol] | \overline{BM1} | [symbol] | BM0 | | | [symbol] | PR2 | | | [symbol] | \overline{PR0} | [symbol] | \overline{(Th ≧ Q + 1)} | | | | | | | [symbol] | m > Q | | | | | | |
| | ≠ | | | BM2 | [symbol] | \overline{BM1} | [symbol] | BM0 | | | [symbol] | PR2 | | | [symbol] | PR0 | | | | | | | | | | | [symbol] | m ≧ Q + 1 | | | | |
| | + | | | BM2 | [symbol] | \overline{BM1} | [symbol] | BM0 | | | [symbol] | PR2 | | | | | [symbol] | (Th ≧ Q + 1) | | | | | | | | | [symbol] | m ≧ Q + 1 | | | | |
| | + | | | BM2 | [symbol] | BM1 | [symbol] | \overline{BM0} | | | [symbol] | PR2 | | | | | | | [symbol] | (Th ≧ Q + 2) | | | | | | | [symbol] | m ≧ Q + 1 | | | | |
| | + | | | BM2 | [symbol] | BM1 | [symbol] | \overline{BM0} | | | [symbol] | PR2 | [symbol] | \overline{PR1} | | | [symbol] | \overline{(Th ≧ Q + 1)} | | | | | | | [symbol] | m > Q | | | | | | |
| | ≠ | | | BM2 | [symbol] | BM1 | [symbol] | \overline{BM0} | | | [symbol] | PR2 | [symbol] | PR1 | | | | | | | | | | | | | [symbol] | m ≧ Q + 1 | | | | |
| | + | | | BM2 | [symbol] | BM1 | [symbol] | \overline{BM0} | | | [symbol] | PR2 | | | | | [symbol] | (Th ≧ Q + 1) | | | | | | | | | [symbol] | m ≧ Q + 1 | | | | |
| | + | | | BM2 | [symbol] | BM1 | [symbol] | BM0 | | | [symbol] | PR2 | | | | | | | | | [symbol] | (Th ≧ Q + 3) | | | | | | | [symbol] | m ≧ Q + 2 | | |
| | ≠ | | | BM2 | [symbol] | BM1 | [symbol] | BM0 | | | [symbol] | \overline{PR2} | [symbol] | \overline{PR1} | | | | | [symbol] | (Th ≧ Q + 2) | | | | | | | | | [symbol] | m ≧ Q + 2 | | |
| | + | | | BM2 | [symbol] | BM1 | [symbol] | BM0 | | | [symbol] | PR2 | [symbol] | \overline{PR1} | [symbol] | \overline{PR0} | [symbol] | \overline{(Th ≧ Q + 1)} | | | | | | | [symbol] | m > Q | | | | | | |
| | + | | | BM2 | [symbol] | BM1 | [symbol] | BM0 | | | [symbol] | PR2 | [symbol] | PR1 | | | [symbol] | (Th ≧ Q + 1) | [symbol] | (Th ≧ Q + 2) | | | | | | | [symbol] | m ≧ Q + 1 | | | | |
| | + | | | BM2 | [symbol] | BM1 | [symbol] | BM0 | | | [symbol] | PR2 | [symbol] | \overline{PR1} | [symbol] | PR0 | [symbol] | \overline{(Th ≧ Q + 1)} | | | | | [symbol] | m ≧ Q + 1 | | | | | | | | |
| | ≠ | | | BM2 | [symbol] | BM1 | [symbol] | BM0 | | | [symbol] | PR2 | [symbol] | PR1 | [symbol] | \overline{PR0} | [symbol] | \overline{(Th ≧ Q + 1)} | | | | | [symbol] | m ≧ Q + 1 | | | | | | | | |
| | + | | | BM2 | [symbol] | BM1 | [symbol] | BM0 | | | [symbol] | PR2 | [symbol] | PR1 | [symbol] | PR0 | | | | | | | | | | | | | [symbol] | m ≧ Q + 2 | | |
| | + | | | BM2 | [symbol] | BM1 | [symbol] | BM0 | | | [symbol] | PR2 | [symbol] | PR1 | | | [symbol] | (Th ≧ Q + 1) | | | | | | | | | | | [symbol] | m ≧ Q + 2 | | |
| [symbol] | = | BM3 | [symbol] | \overline{BM2} | [symbol] | \overline{BM1} | [symbol] | \overline{BM0} | [symbol] | PR3 | | | | | | | | | | | | | | | [symbol] | m > Q | | | | | | |
| | + | BM3 | [symbol] | \overline{BM2} | [symbol] | \overline{BM1} | [symbol] | \overline{BM0} | | | | | | | | | | | [symbol] | (Th ≧ Q + 1) | | | | | | | [symbol] | m > Q | | | | |
| | + | BM3 | [symbol] | \overline{BM2} | [symbol] | \overline{BM1} | [symbol] | BM0 | [symbol] | \overline{PR3} | | | | | | | | | [symbol] | (Th ≧ Q + 2) | | | | | | | [symbol] | m ≧ Q + 1 | | | | |
| | + | BM3 | [symbol] | \overline{BM2} | [symbol] | \overline{BM1} | [symbol] | \overline{BM0} | [symbol] | \overline{PR3} | | | | | [symbol] | PR0 | [symbol] | (Th ≧ Q + 1) | | | | | | | | | [symbol] | m > Q | | | | |
| | + | BM3 | [symbol] | \overline{BM2} | [symbol] | \overline{BM1} | [symbol] | \overline{BM0} | [symbol] | PR3 | | | | | [symbol] | PR0 | | | | | | | | | | | [symbol] | m ≧ Q + 1 | | | | |
| | + | BM3 | [symbol] | \overline{BM2} | [symbol] | \overline{BM1} | [symbol] | \overline{BM0} | [symbol] | PR3 | | | | | | | [symbol] | (Th ≧ Q + 1) | | | | | | | | | [symbol] | m ≧ Q + 1 | | | | |
| | + | BM3 | [symbol] | \overline{BM2} | [symbol] | BM1 | [symbol] | \overline{BM0} | [symbol] | \overline{PR3} | | | | | | | | | [symbol] | m ≧ Q + 1 | | | | | | | | | | | | |
| | + | BM3 | [symbol] | \overline{BM2} | [symbol] | \overline{BM1} | [symbol] | \overline{BM0} | [symbol] | PR3 | | | [symbol] | PR1 | | | [symbol] | (Th ≧ Q + 1) | | | | | | | [symbol] | m > Q | | | | | | |
| | + | BM3 | [symbol] | BM2 | [symbol] | \overline{BM1} | [symbol] | \overline{BM0} | [symbol] | PR3 | | | [symbol] | PR1 | | | [symbol] | (Th ≧ Q + 1) | | | | | | | | | | | [symbol] | m ≧ Q + 1 | | |
| | + | BM3 | [symbol] | BM2 | [symbol] | \overline{BM1} | [symbol] | \overline{BM0} | [symbol] | PR3 | | | | | | | [symbol] | (Th ≧ Q + 1) | | | | | | | | | [symbol] | m ≧ Q + 1 | | | | |
| | + | BM3 | [symbol] | BM2 | [symbol] | \overline{BM1} | [symbol] | \overline{BM0} | [symbol] | PR3 | | | | | | | | | [symbol] | (Th ≧ Q +2) | | | | | | | [symbol] | m ≧ Q + 1 | | | | |
| | + | BM3 | [symbol] | BM2 | [symbol] | BM1 | [symbol] | BM0 | [symbol] | PR3 | [symbol] | PR2 | | | | | [symbol] | (Th ≧ Q + 1) | | | | | | | [symbol] | m > Q | | | | | | |
| | + | BM3 | [symbol] | \overline{BM2} | [symbol] | BM1 | [symbol] | BM0 | [symbol] | PR3 | [symbol] | PR2 | | | | | | | | | | | | | | | [symbol] | m ≧ Q + 1 | | | | |
| | ≠ | BM3 | [symbol] | \overline{BM2} | [symbol] | BM1 | [symbol] | BM0 | [symbol] | PR3 | | | | | | | [symbol] | (Th ≧ Q + 1) | | | | | | | | | [symbol] | m ≧ Q + 1 | | | | |
| | ≠ | BM3 | [symbol] | \overline{BM2} | [symbol] | BM1 | [symbol] | BM0 | [symbol] | PR3 | | | | | | | | | | | [symbol] | (Th ≧ Q + 3) | | | | | | | [symbol] | m ≧ Q + 2 | | |
| | + | BM3 | [symbol] | \overline{BM2} | [symbol] | BM1 | [symbol] | BM0 | [symbol] | PR3 | | | [symbol] | PR1 | | | | | [symbol] | (Th ≧ Q +’) | | | | | | | | | [symbol] | m ≧ Q + 2 | | |
| | + | BM3 | [symbol] | \overline{BM2} | [symbol] | BM1 | [symbol] | BM0 | [symbol] | PR3 | | | [symbol] | PR1 | [symbol] | PR0 | [symbol] | (Th ≧ Q + 1) | | | | | | | [symbol] | m > Q | | | | | | |
| | ≠ | BM3 | [symbol] | \overline{BM2} | [symbol] | BM1 | [symbol] | BM0 | [symbol] | PR3 | | | [symbol] | PR1 | | | [symbol] | (Th ≧ Q + 1) | [symbol] | (Th ≧ Q + 2) | | | | | | | [symbol] | m ≧ Q + 1 | | | | |
| | + | BM3 | [symbol] | \overline{BM2} | [symbol] | BM1 | [symbol] | BM0 | [symbol] | PR3 | | | [symbol] | PR1 | [symbol] | PR0 | [symbol] | (Th ≧ Q + 1) | | | | | | | | | [symbol] | m ≧ Q + 1 | | | | |
| | + | BM3 | [symbol] | \overline{BM2} | [symbol] | BM1 | [symbol] | BM0 | [symbol] | PR3 | | | [symbol] | PR1 | [symbol] | PR0 | [symbol] | (Th ≧ Q + 1) | | | | | | | | | [symbol] | m ≧ Q + 1 | | | | |
| | + | BM3 | [symbol] | BM2 | [symbol] | BM1 | [symbol] | BM0 | [symbol] | PR3 | | | [symbol] | PR1 | [symbol] | PR0 | | | | | | | | | | | | | [symbol] | m ≧ Q + 2 | | |
| | + | BM3 | [symbol] | BM2 | [symbol] | \overline{BM1} | [symbol] | BM0 | [symbol] | PR3 | | | [symbol] | PR1 | | | [symbol] | (Th ≧ Q + 1) | | | | | | | | | | | [symbol] | m ≧ Q + 2 | | |
| | + | BM3 | [symbol] | BM2 | [symbol] | \overline{BM1} | [symbol] | BM0 | [symbol] | PR3 | | | | | | | | | | | [symbol] | (Th ≧ Q + 3) | | | | | | | [symbol] | m ≧ Q + 2 | | |
| | + | BM3 | [symbol] | BM2 | [symbol] | \overline{BM1} | [symbol] | BM0 | [symbol] | PR3 | [symbol] | PR2 | | | | | | | [symbol] | (Th ≧ Q + 3) | | | | | | | | | [symbol] | m ≧ Q + 2 | | |
| | + | BM3 | [symbol] | BM2 | [symbol] | \overline{BM1} | [symbol] | BM0 | [symbol] | PR3 | [symbol] | PR2 | | | [symbol] | \overline{PR0} | [symbol] | \overline{(Th ≧ Q + 1)} | | | | | | | [symbol] | m > Q | | | | | | |
| | + | BM3 | [symbol] | BM2 | [symbol] | \overline{BM1} | [symbol] | BM0 | [symbol] | PR3 | [symbol] | PR2 | | | | | [symbol] | (Th ≧ Q + 1) | [symbol] | \overline{(Th ≧ Q + 2)} | | | | | | | [symbol] | m ≧ Q + 1 | | | | |
| | + | BM3 | [symbol] | BM2 | [symbol] | \overline{BM1} | [symbol] | BM0 | [symbol] | PR3 | [symbol] | PR2 | | | [symbol] | PR0 | [symbol] | \overline{(Th ≧ Q + 1)} | | | | | | | | | [symbol] | m ≧ Q + 1 | | | | |
| | + | BM3 | [symbol] | BM2 | [symbol] | \overline{BM1} | [symbol] | BM0 | [symbol] | PR3 | [symbol] | PR2 | | | [symbol] | PR0 | [symbol] | \overline{(Th ≧ Q + 1)} | | | | | | | | | [symbol] | m ≧ Q + 1 | | | | |
| | + | BM3 | [symbol] | BM2 | [symbol] | \overline{BM1} | [symbol] | BM0 | [symbol] | PR3 | [symbol] | PR2 | | | [symbol] | PR0 | | | | | | | | | | | | | [symbol] | m ≧ Q + 2 | | |
| | + | BM3 | [symbol] | BM2 | [symbol] | BM1 | [symbol] | BM0 | [symbol] | PR3 | [symbol] | PR2 | | | | | [symbol] | (Th ≧ Q + 1) | | | | | | | | | | | [symbol] | m ≧ Q + 2 | | |
| | + | BM3 | [symbol] | BM2 | [symbol] | BM1 | [symbol] | \overline{BM0} | [symbol] | PR3 | | | | | | | | | | | [symbol] | (Th ≧ Q + 3) | | | | | | | [symbol] | m ≧ Q + 2 | | |
| | + | BM3 | [symbol] | BM2 | [symbol] | BM1 | [symbol] | \overline{BM0} | [symbol] | PR3 | [symbol] | \overline{PR2} | | | | | | | | | | | | | | | | | [symbol] | m ≧ Q + 2 | | |
| | + | BM3 | [symbol] | BM2 | [symbol] | BM1 | [symbol] | \overline{BM0} | [symbol] | PR3 | [symbol] | \overline{PR2} | [symbol] | \overline{PR1} | | | [symbol] | \overline{(Th ≧ Q + 1)} | | | | | | | [symbol] | m > Q | | | | | | |
| | + | BM3 | [symbol] | BM2 | [symbol] | BM1 | [symbol] | \overline{BM0} | [symbol] | PR3 | [symbol] | \overline{PR2} | | | | | [symbol] | \overline{(Th ≧ Q + 1)} | [symbol] | \overline{(Th ≧ Q + 2)} | | | | | | | [symbol] | m ≧ Q + 1 | | | | |
| | ≠ | BM3 | [symbol] | BM2 | [symbol] | BM1 | [symbol] | \overline{BM0} | [symbol] | PR3 | [symbol] | \overline{PR2} | [symbol] | PR1 | | | [symbol] | \overline{(Th ≧ Q + 1)} | | | | | | | | | [symbol] | m ≧ Q + 1 | | | | |
| | + | BM3 | [symbol] | BM2 | [symbol] | BM1 | [symbol] | \overline{BM0} | [symbol] | PR3 | [symbol] | PR2 | [symbol] | \overline{PR1} | | | [symbol] | (Th ≧ Q + 1) | | | | | | | | | [symbol] | m ≧ Q + 1 | | | | |
| | + | BM3 | [symbol] | BM2 | [symbol] | BM1 | [symbol] | \overline{BM0} | [symbol] | PR3 | [symbol] | PR2 | [symbol] | PR1 | | | | | | | | | | | | | | | [symbol] | m ≧ Q + 1 | | |
| | + | BM3 | [symbol] | BM2 | [symbol] | BM1 | [symbol] | \overline{BM0} | [symbol] | PR3 | [symbol] | PR2 | | | | | [symbol] | (Th ≧ Q + 1) | | | | | | | | | | | [symbol] | m ≧ Q + 1 | | |
| | + | BM3 | [symbol] | BM2 | [symbol] | BM1 | [symbol] | BM0 | [symbol] | \overline{PR3} | | | | | | | | | | | | | [symbol] | (Th ≧ Q + 3) | | | | | | | [symbol] | m ≧ |
| | | | | | | | | | | | | | | | | | | | | | | | | | | | | | | | | Q + 3 |
| | + | BM3 | [symbol] | BM2 | [symbol] | BM1 | [symbol] | BM0 | [symbol] | PR3 | [symbol] | \overline{PR2} | [symbol] | \overline{PR1} | [symbol] | \overline{PR0} | [symbol] | \overline{(Th ≧ Q + 1)} | | | | | | | [symbol] | m > Q | | | | | | |
| | + | BM3 | [symbol] | BM2 | [symbol] | BM1 | [symbol] | BM0 | [symbol] | PR3 | [symbol] | PR2 | [symbol] | PR1 | | | [symbol] | (Th ≧ Q + 1) | [symbol] | (Th ≧ Q + 2) | | | | | | | | | [symbol] | m ≧ Q + 1 | | |
| | + | BM3 | [symbol] | BM2 | [symbol] | BM1 | [symbol] | BM0 | [symbol] | PR3 | [symbol] | PR2 | [symbol] | PR1 | | | | | [symbol] | (Th ≧ Q + 2) | [symbol] | \overline{(Th ≧ Q + 3)} | | | | | | | [symbol] | m ≧ Q + 2 | | |
| | + | BM3 | [symbol] | BM2 | [symbol] | BM1 | [symbol] | BM0 | [symbol] | PR3 | [symbol] | PR2 | [symbol] | PR1 | | | [symbol] | (Th ≧ Q + 1) | | | [symbol] | \overline{(Th ≧ Q + 3)} | | | | | | | [symbol] | m ≧ Q + 2 | | |

In accordance with the prior art, processing for the write decision is executed cycle by cycle one item of data at a time, In accordance with the embodiment of the present invention, it is possible to execute write-decision processing over a period of time that is four times (i.e., at a length that is four times) that of the prior art. This has the effect of reducing the operating speed of the write decision unit. In other words, a write decision becomes possible even when the operating frequency of the write decision unit is set to a low level.

As mentioned above, an explosive increase in network traffic due to the Internet and an increase in the speed of ATM networks owing to the use of optical fiber or the like have been accompanied by efforts to raise the speed and enlarge the scale of ATM switches. Examples of architectures of ordinary ATM switches are of the output-buffer type, shared-buffer type, input-buffer type and cross-point type, etc. The output-buffer-type switch, for example, has a high throughput and control is simple. However, in order to multiplex and buffer input ATM cells with a switch of this type, processing speed is a bottleneck and it is difficult to obtain a high input/output link speed. The present invention is applied to memory write decision processing when such buffering of ATM cells is carried out.

Described next will be an embodiment of the invention in which a memory management unit for performing a write-enable/disable decision simultaneously for multiple items of data is applied to an ATM switch.

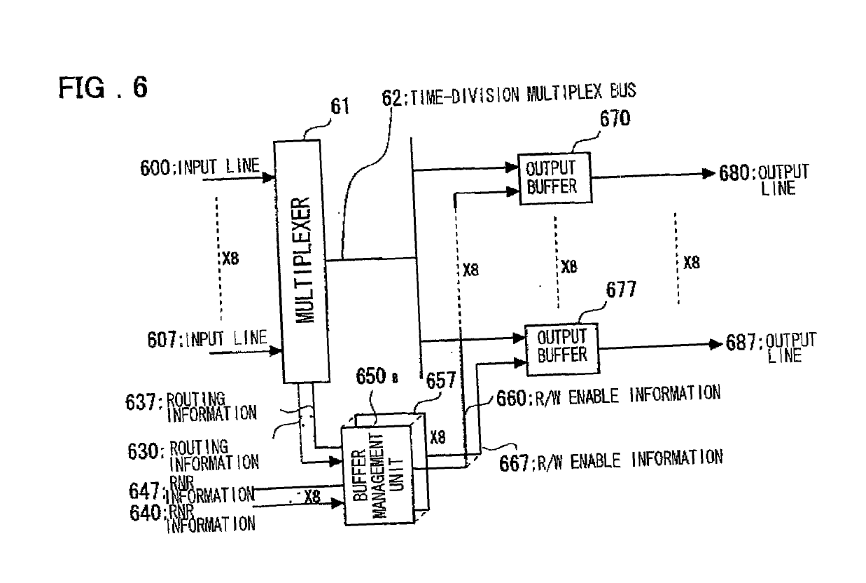

FIG. 6 is a diagram illustrating the structure of an output-buffer-type ATM switch, which has eight input/output lines, to which the present invention is applied. Since the number of output buffers (which correspond to the FIFO memory described with reference to FIG. 1) is eight, which is equal to the number of lines, eight buffer management units 650 to 657 for managing and controlling the individual output buffers are provided. A cell-discard decision circuit (not shown) is included in each of the buffer management units 650 to 657.

First, cells that are supplied from the input lines 600 to 607 are time-division multiplexed in the order of the lines by a multiplexer 61, and the multiplexed signal is output from the multiplexer 61 to a bus 62.

A cell contains information indicating the validity/invalidity of the cell, information indicating priority for cell discard, and information (referred to as “PA information”) indicating to which output line the cell is to be output. On the basis of these items of information, the multiplexer 61 create routing information 630 to 637 delivered to the buffer management units 650 to 657.

The routing information 630 to 637 comprises bitmap information and information indicating priority for cell discard. The bitmap information becomes active (logic value “1”) if the information representing validity/invalidity of a cell is indicative of validity and, moreover, the PA information coincides with the output line handled by the respective one of the buffer management units 650 to 657.

The buffer management units 650 to 657 provided for respective ones of output lines 680 to 687 each creates write information, which is a signal that specifies writing to the output buffer of an input cell, from routing information received by the respective buffer management unit, the maximum capacity of the output buffer held within the buffer management unit, threshold-value information for discarding low-priority cells, and current amount of cell accumulation (queue length) in the output buffer.

Further, the buffer management units 650 to 657 create read information, namely signals that specify read-out of cells from the output buffers 670 to 677, based on RNR information 640 to 647 of respective ones of the output lines that are supplied from a downstream device (not shown) and the queue length information.

The buffer management units 650 to 657 multiplex write information and read information and output the multiplexed information to respective ones of the output buffers 670 to 677 as read/write (R/W) enable information 660 to 667.

The output buffers 670 to 677 performs alignment of the phases of the multiplexed cells that the output buffers 670 to 677 have received from the multiplexer 61 and the R/W enable information that the output buffers 670 to 677 have received from the buffer management units 650 to 657, the output buffers 670 to 677 write cells to respective output buffer memories in accordance with write information contained in the R/W enable information and read out cells, which have been stored in the respective output buffer memories, in accordance with read information contained in the R/W enable information.

The cells that have read out of the output buffers 670 to 677 are delivered to the downstream device (nor shown) via the output lines 680 to 687.

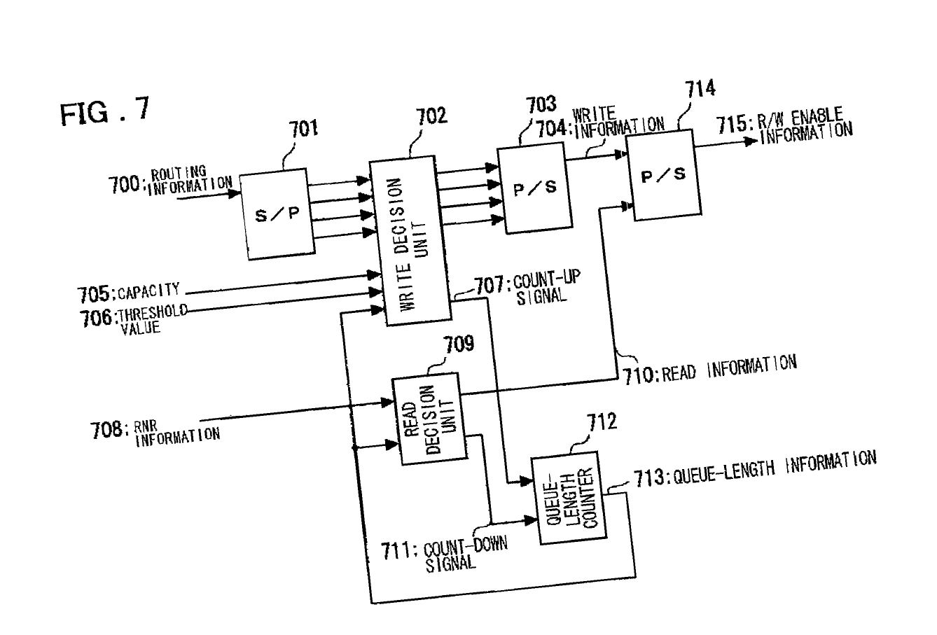

FIG. 7 is a diagram illustrating the structure of a buffer management unit (see FIG. 6) that incorporates a memory-write decision circuit according to an embodiment of the present invention.

As compared with the arrangement of FIG. 3, the buffer management unit shown in FIG. 7 is additionally provided with a parallel-to-serial conversion circuit 714 for multiplexing write information 704 and read information and outputting an R/W enable signal 715.

The R/W enable information 715 that is output from the parallel-to-serial conversion circuit 714 is fed to the output buffers 670 to 677 (see FIG. 6) that are provided for respective ones of the output lines.

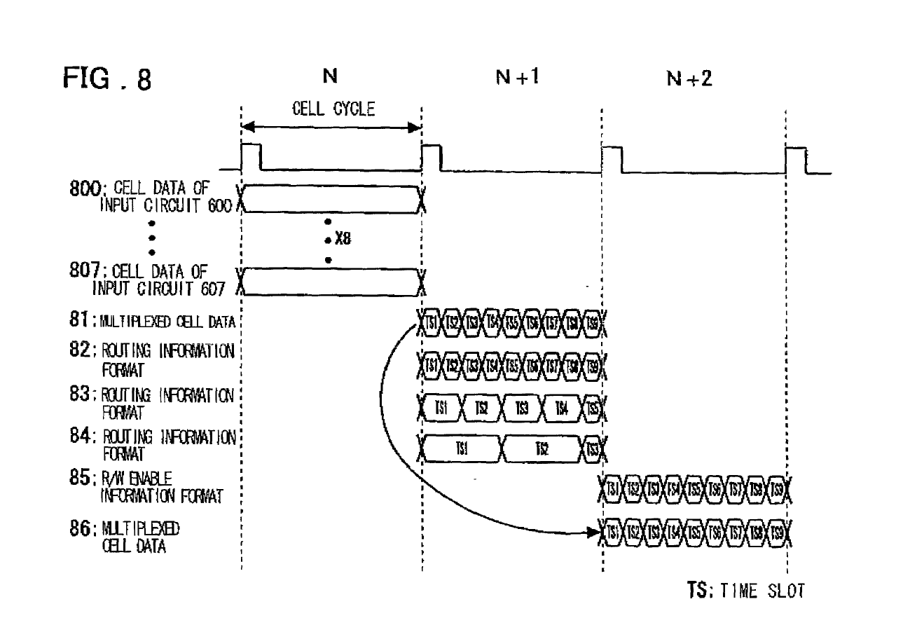

The operating timing in the buffer management unit of FIG. 7 from receipt of routing information 700 to output of the R/W enable information 715 is as shown in FIG. 8. Here the unit time needed to transfer one cell over input and output lines of the switch shall be termed as “cell cycle”.

The cell switching processing of this switch is pipeline processing executed every cell cycle. In the case of an 8×8 output-buffer-type switch, the speed of cell data over an internal multiplex bus (62 in FIG. 6) is (8+1)V, where V represents the line speed of input and output lines.

Specifically, a time interval of one cell cycle is divided up into nine time slots (TS), an input cells to be written to memory are multiplexed line by line to the first eight slots. That is, the cell data on the multiplex bus is data of input lines 600 to 607 multiplexed to TS1 to TS8. The time slot TS9 is vacant.

With regard to the speed of the multiplex bus, the speed within the switch is given by (N+1)×V, where V represents the speed of the input line and N the number of input lines.

In accordance with write data that has been stored in TS1 to TS8 of the routing information, the output buffers write the multiplexed cell data (that has been stored in time slots TS1 to TS8 on the multiplex bus) to the output buffers successively. On the output-buffer read-out side, one cell is read out in accordance with the read information in the routing information TS9, after which a speed conversion (demultiplexing) is performed to achieve matching with the speed of the output line.

Reference will be had to FIGS. 6 and 8 to describe operation at the time of basic cell-by-cell processing in an 8×8 output-buffer-type switch.

A cell 800 that has been entered from input line 600 (see FIG. 6) in an Nth cell cycle is multiplexed to the position of TS1 of multiplexed cell data 81 on the multiplex bus 62 in an (N+1)th cell cycle.

Similarly, a cell 807 that has entered from input line 607 (see FIG. 6) in the Nth cell cycle is multiplexed to the position of TS8 of multiplexed cell data 81 on the multiplex bus 62 in the (N+1)th cell cycle.

Further, routing information extracted and created from cell 800 is multiplexed to the position of TS1 of multiplexed routing information 82.

Similarly, routing information extracted and created from cell 807 is multiplexed to the position of TS8 of the multiplexed routing information 82.

Thus, cells 800 to 807 (cells 801 to 806 are not shown in FIG. 8) of eight input lines are multiplexed sequentially to the positions of TS1 to TS8 of the multiplexed cell data 81 on multiplex bus 62 (see FIG. 6), and multiple items of routing information extracted and created from these input cells are multiplexed sequentially to the positions of TS1 to TS8 of the multiplexed routing information 82.

Describing the operations of the buffer management units individually, first the buffer management unit 650 corresponding to the output buffer 670 creates write information and multiplexes it to TS1 of R/W enable information 85 by referring to the routing information, etc., of cell 800 that has been multiplexed to the leading time slot TS1 of the multiplexed routing information 82. This is processing for writing a cell to the output buffer.

Thenceforth, in a sequential manner, the buffer management unit 650 executes this processing cell by cell (on a per-cell basis) until write information is finally created and multiplexed to TS8 of the R/W enable information 85 by referring to the routing information, etc., of cell 807 that has been multiplexed to the time slot TS8 of the multiplexed routing information 82.

Next, as processing for reading a cell from the output buffer, the buffer management unit 650 creates read information 660 to 667 for the output buffer 670 to 677 on the basis of RNR information 640 to 647 of the respective output line and multiplexes this information to TS9 of the R/W enable information 85.

The buffer management units 650 to 657 are eight in number for respective ones of the output buffers 670 to 677 and operate independently of one another.

After aligning the phase of the cell data on the multiplex bus 62 and the phases of the R/W enable information 660 to 667 received separately from the buffer management units 650 to 657 (see the phase relationship between the R/W enable information 85 and the multiplexed cell data 86 in FIG. 8), the output buffers 670 to 677, in accordance with the R/W enable information, write data to the output buffers from the leading cell that has been multiplexed to TS1 of the multiplexed cell data 81.

Further, on the read-out side of the output buffers, one cell is read out in accordance with the read information in the routing information TS9, after which a speed conversion (demultiplexing) is performed to achieve matching with the output-line speed.

Cells that have been read out of memory are sent to the downstream device (not shown) from the output lines 680 to 687 after the speed in conversion.

Next, reference will be had to FIGS. 7 and 8 to describe the details of operation of an output-buffer-type switch in a case where use is made of a write decision circuit capable of processing four items of data simultaneously in accordance with the embodiment of the invention shown in FIG. 6.

With regard to multiplexed output of cell data and multiplexed output of routing information in the multiplexer 61 of FIG. 6, these operations are similar to those of the cell-by-cell processing switch described above.

With reference to FIG. 7, a received routing information 700 is subjected to a speed conversion to one-fourth and is made parallel information corresponding to four input lines by a serial-to-parallel conversion circuit 701 in the buffer management units 650 to 657. More specifically, routing information of cells 800 to 803 in FIG. 8 is multiplexed to the position of TS1 of multiplexed routing information 84, and routing information of cells 804 to 807 is similarly multiplexed to the position of TS2 of multiplexed routing information 84.

A decision to write data to an output buffer is made in a write decision unit 702 based upon the multiplexed routing information 84 of reduced speed.

Consider the buffer management unit 650 that corresponds to the output line 680. First, as processing for writing a cell to the output buffer 670, the buffer management unit 650 refers to routing information, etc., of cells 800 to 803 multiplexed to the leading time slot TS1 of this multiplexed routing information 84, creates the leading four cell's worth of output-buffer write information over a period of four time slots, and multiplexes this information to the positions of time slots TS1 to TS4 of the R/W enable information 85 transmitted to the output buffer.

Next, the buffer management unit 650 refers to the routing information, etc., of cells 804 to 807 multiplexed to the time slot TS2 of the multiplexed routing information 84 the speed of which has been reduced, creates buffer write information of output buffer 670 over a period of four time slots, and multiplexes this information to the positions of time slots TS5 to TS8 of the R/W enable information 85.

Next, as processing for cell read-out from the output buffer 670, the buffer management unit 650 creates read information from the output buffer based upon RNR information, etc., of output line 680 and multiplexes this information to time slot TS9 of the R/W enable information 85.

The operation of the buffer management units 651 (not shown) to 657 is the same and these operate independently of one another.

The output buffers 670 to 677 align the phases of the cell data on the multiplex bus and the R/W enable information 660 to 667 received individually (see the R/W enable information 85 and the multiplexed cell data 86 in FIG. 8) and, in accordance with the R/W enable information, write data to the output buffers from the leading cell that has been multiplexed to TS1 of the multiplexed cell data 81.

Further, on the read-out side of the output buffers, one cell is read out in accordance with the read information in the routing information TS9, after which a speed conversion (demultiplexing) is performed to achieve matching with the output-line speed.

Cells that have been read out of the output buffers are sent to the downstream device (not shown) from the output lines 680 to 687 after the speed conversion.

It should be noted that there is also a version available in which the serial-to-parallel conversion circuit 701 for the speed conversion shown in FIG. 7 is incorporated in the multiplexer 61. In such case, the transmission format of the routing information 630 to 637 received by the buffer management units 650 to 657 becomes lower-speed format 84.

Further, the write decision circuit in the present invention supports the simultaneous processing of two and three items of data besides the simultaneous processing of four items of data.

More specifically, in the case of simultaneous processing of two items of data, the data expansion (the multiplex number) of the serial/parallel conversion circuit 701 and parallel/serial conversion circuit 703 is made two items of data and the write decision unit 702 uses only two items of data on the LSB (least significant bit) side among four items of data.

The routing information that the write decision unit 702 receives in this case has the format 83 shown in FIG. 8.

In the case of simultaneous processing of three items of data, the data expansion of the serial/parallel conversion circuit 701 and parallel/serial conversion circuit 703 is made three items of data and the write decision unit 702 uses only three items of data on the LSB side among four items of data.

The meritorious effects of the present invention are summarized as follows.

Thus, in accordance with the present invention as described above, it is possible to reduce the operating speed of a write decision unit in memory control that requires higher speed. The invention therefore is well suited for application to the buffer management unit of an output-buffer-type ATM switch.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items might fall under the modifications aforementioned.

What is claimed is:

1. A memory control circuit for controlling at least write operation of data to a memory having a predetermined memory capacity wherein data to be written to the memory is provided with a priority; and
wherein said memory control circuit includes means that renders a write-enable/disable decision in such a manner that data of relatively low priority will not be written to the memory in excess of a preset threshold value on the basis of a comparison result by means for comparing present amount of data accumulation in the memory and the threshold value, and data of relatively high priority will not be written to the memory in excess of the capacity of the memory on the basis of a comparison result by means for comparing the present amount of data accumulation in the memory and the capacity of the memory,
said memory control circuit comprising means for rendering said write-enable/disable decision simultaneously with respect to a plurality of items of data.

2. A memory control circuit having a memory management unit which receives, as control information, information that has been added onto input data for indicating validity or invalidity of the data, and priority information that has been added onto input data relating to discarding of this data, renders an enable/disable decision with regard to writing of the input data to a FIFO (First In and First Out) memory, which accumulates the data) based upon maximum memory capacity of the FIFO memory, predetermined threshold-value information for discarding data of low priority and present queue length, which represents present amount of data accumulation in said memory, generates a write signal based upon result of the decision, and sends the write signal to said memory;
said memory receiving the write signal from said memory management unit, storing the input data in said memory in case of the write signal indicating write-enable, and reading out and outputting data, which has been stored in said memory, based upon a read signal output from said memory management unit;
wherein said memory management unit comprises:
conversion means which converts a plurality of items of the control information serially input thereto, to parallel control information; and
write decision means which compares the threshold value and the queue length if, based upon the control information, the input data is valid data and the data has a relatively low priority, and compares the maximum capacity of said memory and the queue length if, based upon the control information, the input data is valid data and the data has a relatively high priority, thereby to render the enable/disable decision regarding writing of the input data to said memory; said write-enable/disable decision being rendered in parallel with respect to a plurality of items of the control information that have been made parallel by said conversion means.

3. A memory control circuit having a memory management unit which receives, as control information, information that has been added onto input data for indicating the validity or invalidity of the data, and priority information that has been added onto input data relating to discarding of this data, renders an enable/disable decision with regard to writing of the input data to a FIFO memory, which accumulates the data, based upon maximum memory capacity of the FIFO memory, predetermined threshold-value information for discarding data of low priority and present queue length, which represents present amount of data accumulation in said memory, generates a write signal based upon result of the decision, and sends the write signal to said memory;
said memory receiving the write signal from said memory management unit, storing the input data in said memory in case of the write signal indicating write-enable, and reading out and outputting data, which has been stored in said memory, based upon a read signal output from said memory management unit;
wherein said memory management unit includes:
a queue-length counter for managing queue length, which represents amount of data accumulation in said memory, by being counted up in accordance with number of items of data to be written to said memory and counted down when data is read out of said memory;
a serial-to-parallel converter which receives a plurality of (N) items of the control information serially and converts said N items of serial control information to N items of parallel control information;
a write decision unit, which receives the N items of parallel control information output from said serial-to-parallel converter,
compares the threshold value and the queue length if, based upon the control information, the input data is valid data and the data has a relatively low priority,
compares the maximum capacity of said memory and the queue length if, based upon the control information, the input data is valid data and the data has a relatively high priority,
thereby to render, in parallel, an enable/disable decision with regard to writing of N items of data to said memory, and generate N parallel write signals to output these signals in parallel, and
include means for providing a count-up signal to said queue-length counter so as to count up the queue length in conformity with number of items of data for which writing is allowed among the N items of data; and
a parallel-to-serial converter for converting N write signals, which are output from said write decision unit in parallel, to a serial signal.

4. The memory control circuit as defined in claim 2, wherein said memory management unit has a read decision unit that includes means which generates a memory read signal from an externally entered signal indicating read-enable and the queue length recorded by said queue-length counter, and outputs a count-down signal to said queue-length counter so as to count down said counter when data is read out of said memory.

5. The memory control circuit as defined in claim 3, wherein said memory management unit has a read decision unit that includes means which generates a memory read signal from an externally entered signal indicating read-enable and the queue length recorded by said queue-length counter, and outputs a count-down signal to said queue-length counter so as to count down said counter when data is read out of said memory.

6. The memory control circuit as defined in claim 2, wherein T represents one data cycle of the input data, and said write decision unit renders, in parallel, the enable/disable decision with regard to writing of N items of data to said memory on receipt of N items of parallel control information output from said serial-to-parallel converter, and makes it possible to execute the enable/disable decision with regard to writing of data to said memory in regard to one item of data over a period of time that is N times one data period T.

7. The memory control circuit as defined in claim 3, wherein T represents one data cycle of the input data, and said write decision unit renders, in parallel, the enable/disable decision with regard to writing of N items of data to said memory on receipt of N items of parallel control information output from said serial-to-parallel converter, and makes it possible to execute the enable/disable decision with regard to writing of data to said memory in regard to one item of data over a period of time that is N times one data period T.

8. The memory control circuit as defined in claim 3, wherein said write decision unit comprises:
an adder which generates values of Q+1 to Q+N−1, where Q represents the queue length of said queue-length counter,
a full decision unit which determines whether said memory is full by comparing the maximum capacity of said memory with the queue Length Q and with the values of Q+1 to Q+N−1 output from said adder;
a threshold-value comparator which compares the threshold value with the queue length Q and with the values of Q+1 to Q+N−1 output from said adder; and
N-number of write decision circuits provided for corresponding ones of first to Nth items of control information entered in parallel;
wherein ith (where i is 1 to N) write decision circuit have an ith item of control information input thereto and, if i is any of 2 to N, having first to (i−1)th items of control information input thereto; and
said full decision unit comprises a logic circuit which renders a write-enable/disable decision regarding a first item of data based upon an output from said threshold-value comparator.

9. An ATM switch comprising:
a multiplexer which multiplexes cells from a plurality of input lines;
a plurality of output buffers provided for corresponding ones of output lines;
a plurality of buffer management units, which are provided for corresponding ones of said plurality of output buffers, to which are input control information extracted by said multiplexer and including information indicating cell validity/invalidity and information indicating priority for cell discard, and to which are further input an externally entered output-buffer read-enable signal, for generating write and read-enable signals to be fed to said output buffers;
wherein each of said buffer management units includes
a queue-length counter for managing output-buffer queue length by being counted up in accordance with number of items of cells to be written to said output buffer and counted down when one cell is read out of said output buffer;
a serial-to-parallel converter for converting a plurality of (N) items of the control information, which are input serially thereto, to N items of parallel control information;
a write decision unit which receives the N items of parallel control information, compares a preset threshold value and present queue length if, based upon the control information, the input data is valid data and the data has a relatively low priority, and compares the maximum capacity of said output buffer and the queue length if, based upon the control information, the input data is valid data and the data has a relatively high priority, thereby to render, in parallel, enable/disable decision with regard to writing of N items of cell data to said output buffers, to generate N parallel write signals for outputting said write signals in parallel, said write decision unit further comprising means for outputting a count-up signal to said queue-length counter so as to count up the queue length in conformity with number of cells for which writing is allowed among the N items of data; and
a first parallel-to-serial converter for converting N write signals, which are output from said write decision unit in parallel, to a serial signal.

10. The ATM switch as defined in claim 9, wherein each of said buffer management units further comprises:
a read decision unit that has means for generating an output-buffer read signal from a read-enable signal and the queue length of said queue-length counter, and outputting a count-down signal to said queue-length counter so as to count down said counter by one when one cell is read out of said output buffer; and
a second parallel-to-serial converter for outputting a signal, which is obtained by multiplexing a write signal output from said first parallel-to-serial converter and a read signal output from said read decision unit, to the corresponding output buffer as a serial read/write signal.
